(19) United States
(12) Patent Application Publication
(10) Pub. No.: US 2013/0021436 A1
(43) Pub. Date: Jan. 24, 2013

(54) DECODER, PROJECTING SYSTEM, AND IMAGE PROCESSING METHOD OF THE PROJECTING SYSTEM

(71) Applicants: Yi-Chun Lu, New Taipei City (TW); Yau Wing Chung, New Taipei City (TW)

(72) Inventors: Yi-Chun Lu, New Taipei City (TW); Yau Wing Chung, New Taipei City (TW)

(73) Assignee: OPTOMA CORPORATION, New Taipei City (TW)

(21) Appl. No.: 13/450,484

(22) Filed: Apr. 19, 2012

(30) Foreign Application Priority Data
Jul. 18, 2011 (TW) 100125298

(51) Int. Cl. H04N 13/00

(52) U.S. Cl. 348/43; 348/E13.002

(57) ABSTRACT

A decoder, a projecting system, and an image processing method of the projecting system are provided. The decoder is adapted to the projecting system having a projecting module. The decoder has a decoding circuit and a transceiver. The projecting module outputs a first and a second projected images and a frame switching control signal. The decoding circuit receives and decodes a three-dimensional video signal to generate a first and a second image data to the projecting module. The projecting module generates the first projected image according to the first image data and generates the second projected image according to the second image data. The transceiver receives and transmits the frame switching control signal to the decoding circuit, and the decoding circuit adjusts an output time sequence of the first projected image and the second projected image outputted from the projecting module according to the received frame switching control signal.

### CROSS-REFERENCE TO RELATED APPLICATION

This application claims the priority benefit of Taiwan application serial no. 100125298, filed on Jul. 18, 2011. The entirety of the above-mentioned patent application is hereby incorporated by reference herein and made a part of this specification.

### BACKGROUND OF THE INVENTION

1. Field of the Invention

The invention is related generally to a decoder, a projecting system, and an image processing method of the projecting system, and more particularly to a decoder, projecting system, and image processing method of the projecting system receiving a three-dimensional (3D) video signal.

2. Description of Related Art

Generally speaking, when left and right images are alternately displayed in a rapid and continuous manner and an active pair of shutter glasses is being synchronously turned on and off, the left eye would only see the left images while the right eye would only see the right images, and accordingly human eyes view 3D images.

In a digital light processing link (DLP-Link) projection technique, an image is inserted by light coding between the projecting times of the left eye image and the right eye image. When the shutter glasses detect the inserted images, the on/off states of the left eye shutter unit and the right eye shutter unit are switched. For example, a left eye shutter unit at the on state and a right eye shutter unit at the off state are switched to a left eye shutter unit at the off state and a right eye shutter unit at the on state. However, when a projector projects a right eye image and the left eye shutter unit is on and the right eye shutter unit is off, or when the projector projects a left eye image and the left eye shutter unit is off and the right eye shutter unit is on, the user sees inaccurate 3D images.

U.S. Patent Application Publication No. 2006/0161963 proposed a display apparatus including a decoder, a display controller, a frame buffer, and a display module, and the decoder decodes an image data and transmits the decoded image data to the display module. U.S. Patent Application Publication No. 2010/0091888 proposed a multiple bit rate encoder. A decoder receives an image signal, and the bit rate of the image data is converted from a high bit rate to a low bit rate during a decoding process. Nevertheless, when applied in 3D display techniques, the aforementioned conventional decoders present substantially many problems which still need to be overcome.

### SUMMARY OF THE INVENTION

The invention provides an image processing method of a projecting system, in which a user may view accurate 3D images due to a decoder in the projecting system receiving a frame switching control signal to adjust an output time sequence of projected images.

The invention provides a decoder and a projecting system. A transceiver in the decoder receives a frame switching control signal, and accordingly an output time sequence of projected images is adjusted so the user may view accurate 3D images.

Other objects and advantages of the invention may be further illustrated by the technical features broadly embodied and described as follows.

In order to achieve one or a portion of or all of the objects or other objects, an embodiment of the invention provides a decoder adapted to a projecting system having a projecting module. The projecting module is adapted to output a first projected image, a second projected image, and a frame switching control signal. The decoder includes a decoding circuit and a transceiver. The decoding circuit receives and decodes a three-dimensional (3D) video signal to generate a first image data and a second image data to the projecting module. According to the received frame switching control signal, the decoding circuit adjusts an output time sequence of the first projected image and the second projected image outputted from the projecting module. The projecting module generates the first projected image according to the first image data and generates the second projected image according to the second image data. The transceiver is coupled to the decoding circuit to receive and transmit the frame switching control signal to the decoding circuit.

In order to achieve one or a portion of or all of the objects or other objects, an embodiment of the invention provides a projecting system including a projecting module and a decoder. The projecting module receives a first image data and a second image data and outputs a frame switching control signal. The projecting module generates a first projected image according to the first image data and generates a second projected image according to the second image data. The decoder is coupled to the projecting module and includes a decoding circuit and a transceiver. The decoding circuit receives and decodes a three-dimensional video signal to generate the first image data and the second image data. According to the received frame switching control signal, the decoding circuit adjusts an output time sequence of the first projected image and the second projected image outputted from the projecting module. The transceiver is coupled to the decoding circuit to receive and transmit the frame switching control signal to the decoding circuit.

In order to achieve one or a portion of or all of the objects or other objects, an embodiment of the invention provides an image processing method of a projecting system, including the following steps. A decoding circuit is provided to receive and decode a three-dimensional video signal, and to generate a first image data and a second image data. A projecting module is provided to generate a first projected image according to the first image data, generate a second projected image according to the second image data, and to output a frame switching control signal, wherein the decoding circuit adjusts an output time sequence of the first projected image and the second projected image outputted from the projecting module according to the received frame switching control signal. A transceiver is provided to receive and transmit the frame switching control signal to the decoding circuit.

In summary, embodiments of the invention include at least the following advantages. In embodiments of the invention, the decoder may adjust the output time sequence of the first projected image and the second projected image according to the received frame switching control signal. The adjusted output time sequence may correspond to an on/off time sequence of the two lenses of the light-shielding glasses worn by the user. Accordingly, the user may view accurate 3D projected images.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of a projecting system according to an embodiment of the invention.

FIG. 2 illustrates a sequence of 3D projected images in FIG. 1.

FIG. 3 is a flowchart of an image processing method of a projecting system according to an embodiment of the invention.

FIG. 4 is a schematic view of a projecting system according to an embodiment of the invention.

### DESCRIPTION OF EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

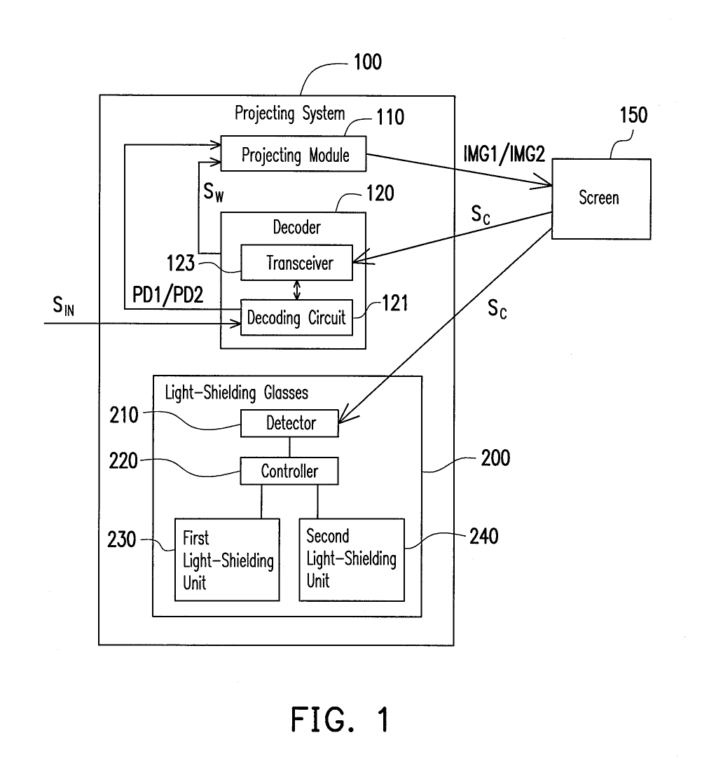

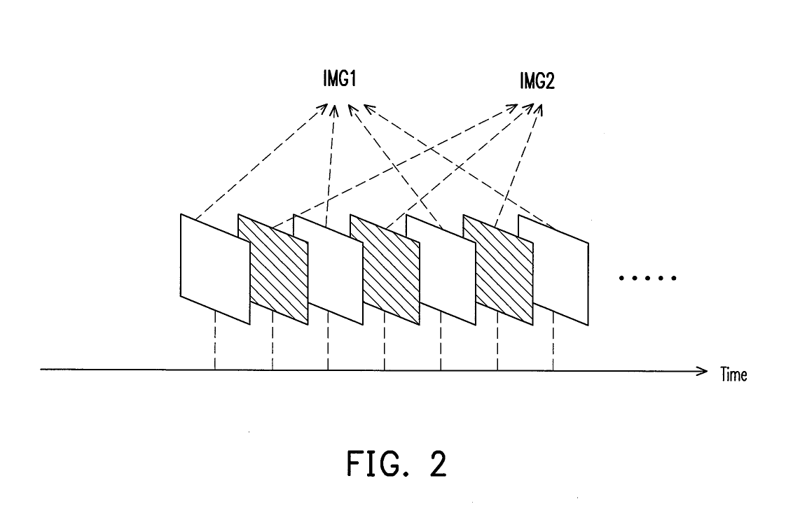

Referring to FIGS. 1 and 2, in the embodiment, a projecting system 100 is a Digital Light Processing (DLP) projecting system capable of projecting three-dimensional (3D) images, for example. Moreover, through a pair of active light-shielding glasses, 3D images may be experienced with human eyes. The projecting system 100 has a projecting module 110 and a decoder 120. The projecting system 100 receives a three-dimensional video signal (3D video signal) S_{IN} and transmits the 3D video signal S_{IN} to the decoder 120. The decoder 120 includes a decoding circuit 121 and a transceiver 123 coupled to the decoding circuit 121. In the embodiment, the decoder 120 is externally assembled with the projecting module 110 as an example, although the invention is not limited thereto. In other words, the decoder 120 may also be embedded in the projecting module 110.

In the embodiment, the projecting system 100 also includes a pair of light-shielding glasses 200. The light-shielding glasses 200 include a detector 210, a controller 220, a first light-shielding unit 230, and a second light-shielding unit 240. The controller 220 is coupled to the detector 210, the first light-shielding unit 230, and the second light-shielding unit 240.

In the embodiment, the 3D video signal S_{IN} may conform to the standard set forth by High Definition Multimedia Interface (HDMI) 1.4, although the invention is not limited thereto. For example, the 3D video signal S_{IN} may also conform to a standard set forth by DisplayPort 1.2, or to a 3D video signal from a video source device (e.g., a Blu-ray player).

In the embodiment, the decoding circuit 121 of the decoder 120 decodes the received 3D video signal S_{IN} to generate a first image data PD1 and a second image data PD2. Moreover, the decoding circuit 121 outputs the first image data PD1 and the second image data PD2 to the projecting module 110 in sequence. The projecting module 110 projects a first projected image IMG1 and a second projected image IMG2 in sequence according to the sequentially received first image data PD1 and second image data PD2. The first projected image IMG1 is generated by the projecting module 110 according to the first image data PD1. One of the eyes (e.g. a left eye) of the user may view the first projected image IMG1 through the first light-shielding unit 230 of the light-shielding glasses 200. The second projected image IMG2 is generated by the projecting module 110 according to the second image data PD2. Another one of the eyes (e.g. a right eye) of the user may view the second projected image IMG2 through the second light-shielding unit 240 of the light-shielding glasses 200.

Specifically, as shown in FIG. 2, the first projected image IMG1 and the second projected image IMG2 are alternately displayed, that is, alternately projected on a screen 150. For example, projected images (e.g., including the first projected image IMG1 and the second projected image IMG2) are displayed at a frame refresh rate of 120 Hz, although the invention is not limited thereto. In the embodiment, the first projected image IMG1 is filtered by the second light-shielding unit 240 of the light-shielding glasses 200, and the second projected image IMG2 is filtered by the first light-shielding unit 230 of the light-shielding glasses 200. In other words, the first light-shielding unit 230 and the second light-shielding unit 240 respectively receive the first projected image IMG1 and the second projected image IMG2. Accordingly, the first projected image IMG1 passes through the first light-shielding unit 230, and the second projected image IMG2 passes through the second light-shielding unit 240. In the embodiment, the first light-shielding unit 230 and the second light-shielding unit 240 of the light-shielding glasses 200 may be respectively a left eye lens and a right eye lens of a pair of active light-shielding glasses (e.g., a pair of liquid crystal shutter glasses).

Referring to FIGS. 1 and 2, in the embodiment, the first light-shielding unit 230 and the second light-shielding unit 240 are controlled by a timing signal of a digital light processing link, such as a frame switching control signal S_{C}. Further, in the embodiment, the frame switching control signal S_{C} is hidden in the projected frame between the first projected image IMG1 and the second projected image IMG2, for serving as synchronization information of the digital light processing link (e.g., the DLP-Link). The detector 210 of the light-shielding glasses 200 of the projecting system 100 may detect the frame switching control signal S_{C}. The controller 220 of the light-shielding glasses 200 alternately turns on the first light-shielding unit 230 and the second light-shielding unit 240 according to the frame switching control signal S_{C}, so the user's two eyes alternately view the first projected image IMG1 and the second projected image IMG2. In the embodiment, the first light-shielding unit 230 in the on state represents the first light-shielding unit 230 may allow an image beam to pass through, and the second light-shielding unit 240 in the on state represents the second light-shielding unit 240 may allow an image beam to pass through. Since the frame switching control signal S_{C} is hidden in the projected frame between the first projected image IMG1 and the second projected image IMG2, the alternating turn on operation is substantially synchronized with the frame refresh rate, in which the rate of the alternating turn on operation is 120 Hz, for example.

In light of the above, the user's two eyes may be alternately covered by turning on the first light-shielding unit 230 and the second light-shielding unit 240 in an alternating manner. Simply speaking, the image receiving operations of the first light-shielding unit 230 and the second light-shielding unit 240 may be turned on and off according to the frame switching control signal S_{C}, and the image receiving operations of the first light-shielding unit 230 and the second light-shielding unit 240 are opposite to each other. On the other hand, the projecting module 110 employs an alternate-frame sequencing technique to alternately display different frames corresponding to each eye, so as to achieve an anticipated effect of each eye viewing a predetermined image.

Furthermore, when the light-shielding glasses 200 receives the frame switching control signal S_{C}, the controller 220 of the light-shielding glasses 200 switches the states of the first light-shielding unit 230 and the second light-shielding unit 240. Assume originally the first light-shielding unit 230 is in the on state and the second light-shielding unit 240 is in the off state, after receiving the frame switching control signal S_{C}, the controller 220 of the light-shielding glasses 200 sets the first light-shielding unit 230 in the off state and sets the second light-shielding unit 240 in the on state. Moreover, when the frame switching control signal S_{C} is received again, then the controller 220 of the light-shielding glasses 200 sets the first light-shielding unit 230 in the on state and sets the second light-shielding unit 240 in the off state. Accordingly, the first light-shielding unit 230 is alternately set in the on and off states, and the second light-shielding unit 240 is also alternately set in the on and off states. Moreover, the turn on time sequence of the first light-shielding unit 230 and the second light-shielding unit 240 is staggered. According to the aforementioned embodiments, the left eye may view the first projected image IMG1 through the first light-shielding unit 230 in the on state, and the right eye may view the second projected image IMG2 through the second light-shielding unit 240 in the on state.

However, conventionally in certain situations (e.g., when the screen 150 is too far from the light-shielding glasses 200, the received frame switching control signal S_{C} is too faint and may not be clearly identified), the left eye may view the second projected image IMG2 through the first light-shielding unit 230 in the on state, and the right eye may view the first projected image IMG1 through the second light-shielding unit 240 in the on state. In other words, the turn on time sequence of the first light-shielding unit 230 and the second light-shielding unit 240 do not correspond to the projecting time sequence of the first projected image IMG1 and the second projected image IMG2 (i.e., the turn on time sequence of the first light-shielding unit 230 and the second light-shielding unit 240 do not correspond to an output time sequence of the first image data PD1 and the second image data PD2) traditionally.

In order to alleviate the foregoing problem, in an embodiment of the invention, a transceiver 123 of the decoder 120 receives and transmits the frame switching control signal S_{C} to the decoding circuit 121. According to the received frame switching control signal S_{C}, the decoding circuit 121 may adjust an output time sequence of the first projected image IMG1 and the second projected image IMG2 outputted from the projecting module 110, so the turn on time sequence of the first light-shielding unit 230 and the second light-shielding unit 240 corresponds to the projecting time sequence of the first projected image IMG1 and the second projected image IMG2, and thereby the user may view accurate 3D projected images. In the numerous embodiments hereafter, various methods of the decoder 120 adjusting the output time sequence of the first projected image IMG1 and the second projected image IMG2 outputted from the projecting module 110 are described. However, it should be noted that, the methods of adjusting the output time sequence of the first projected image IMG1 and the second projected image IMG2 outputted from the projecting module 110 are not limited to the methods described hereafter.

In an embodiment of the invention, the decoder 120 generates a synchronization control signal S_{W} according to the frame switching control signal S_{C} received by the transceiver 123. Moreover, the synchronization control signal S_{W} is transmitted to the projecting module 110 by the transceiver 123, so the projecting module 110 adjusts the output time sequence of the first projected image IMG1 and the second projected image IMG2 according to the synchronization control signal S_{W}.

In an embodiment of the invention, the decoder 120 commands the decoding circuit 121 to suspend the output of the first image data PD1 and the second image data PD2 to the projecting module 110 for a predetermined time according to the frame switching control signal S_{C} received by the transceiver 123, so as to adjust the output time sequence of the first projected image IMG1 and the second projected image IMG2 outputted from the projecting module 110. The predetermined time may be one second, for example, although the invention is not limited thereto. People having ordinary knowledge in the art would realize that the predetermined time may be any arbitrary length of time.

In an embodiment of the invention, the decoder 120 alters an output frequency of the first image data PD1 and the second image data PD2 outputted from the decoding circuit 121 to the projecting module 110 according to the frame switching control signal S_{C} received by the transceiver 123, so as to adjust the output time sequence of the first projected image IMG1 and the second projected image IMG2 outputted from the projecting module 110. For example, an original output setting of the decoding circuit may allow the projecting module 110 to generate image data of 120 frames per second (including the first image data PD1 and the second image data PD2). The output setting of the decoding circuit 121 controlled by the decoder 120 is altered so the projecting module 110 generates image data of 60 frames per second (including the first image data PD1 and the second image data PD2).

In an embodiment of the invention, the decoder 120 alters an output frequency of the first projected image IMG1 and the second projected image IMG2 outputted from the projecting module 110 according to the frame switching control signal S_{C} received by the transceiver 123, so as to adjust the output time sequence of the first projected image IMG1 and the second projected image IMG2 outputted from the projecting module 110. For example, the projecting module 110 originally outputs the first projected image IMG1 and the second projected image IMG2 at a frequency of 120 frames per second. The projecting module 110 controlled by the decoder 120 is altered to output the first projected image IMG1 and the second projected image IMG2 at a frequency of 60 frames per second.

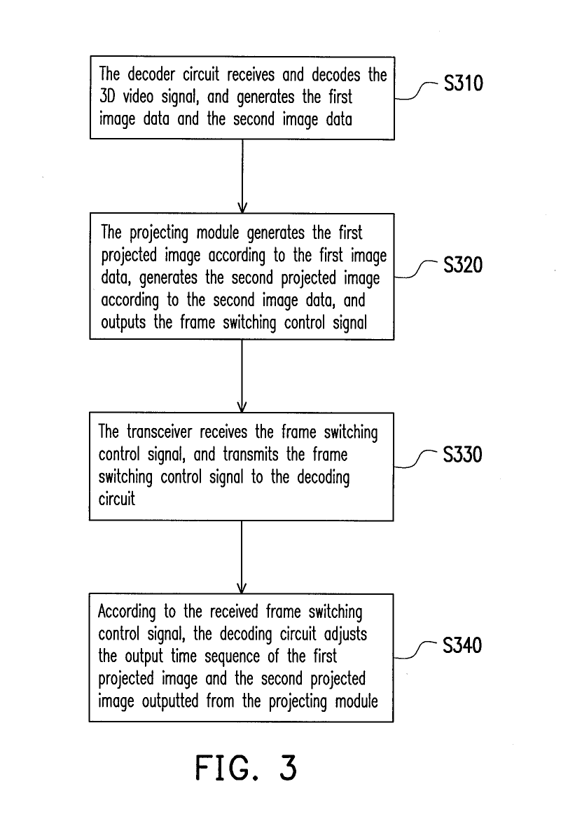

In light of the above, an image processing method adapted for the projecting system may be summarized as below. Moreover, reference may be made to the projecting system 100 depicted in FIG. 1 having the projecting module 110 and the decoder 120, and the decoder 120 includes the decoding circuit 121 and the transceiver 123. Referring to FIGS. 1 and 3 concurrently, in the embodiment, firstly, the decoder circuit 121 receives and decodes a 3D video signal S_{IN}, and generates a first image data PD1 and a second image data PD2 (Step S310). Then the projecting module 110 generates the first projected image IMG1 according to the first image data PD1, generates the second projected image IMG2 according to the second image data PD2, and outputs the frame switching control signal S_{C} (Step S320). Afterwards, the transceiver 123 receives the frame switching control signal S_{C}, and transmits the frame switching control signal S_{C} to the decoding circuit 121 (Step S330). Furthermore, according to the received frame switching control signal S_{C}, the decoding circuit 121 adjusts the output time sequence of the first projected image IMG1 and the second projected image IMG2 outputted from the projecting module 110 (Step S340).

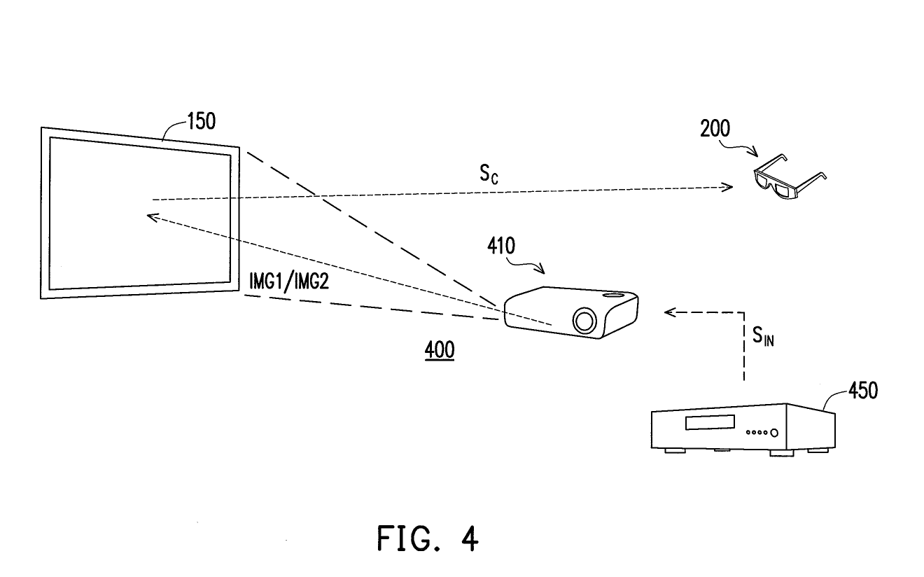

Referring to FIG. 4, in the embodiment, a projecting system 400 has a projecting module 410, a decoder, and a pair of light-shielding glasses 200, in which the decoder is not drawn in FIG. 4, and the decoder may be selectively external or embedded within the projecting module 410. The projecting module 410 receives the 3D video signal S_{IN} from a video source device 450 such as a Blu-ray player, although the invention is not limited thereto. However, the same reference numerals used in the projecting system 400 indicate the same or similar elements described in the projecting system 100, and thus further elaboration is omitted herein.

In view of the foregoing, embodiments of the invention include at least the following advantages. In embodiments of the invention, the transceiver in the decoder receives the frame switching control signal. The decoding circuit in the decoder adjusts the output time sequence of the first projected image and the second projected image according to the received frame switching control signal. After the output time sequence of the first projected image and the second projected image has been adjusted, the turn on time sequence of the first light-shielding unit and the second light-shielding unit those allow the user to view the first projected image and the second projected image corresponds to the projecting time sequence of the first projected image and the second projected image, and thereby the user may view accurate 3D projected images.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A decoder, adapted to a projecting system having a projecting module, the projecting module adapted to output a first projected image, a second projected image, and a frame switching control signal, the decoder comprising:
a decoding circuit, receiving and decoding a three-dimensional video signal to generate a first image data and a second image data to the projecting module, and the decoding circuit adjusting an output time sequence of the first projected image and the second projected image outputted from the projecting module according to the received frame switching control signal, wherein the projecting module generates the first projected image according to the first image data and generates the second projected image according to the second image data; and
a transceiver, coupled to the decoding circuit to receive and transmit the frame switching control signal to the decoding circuit.

2. The decoder as claimed in claim 1, wherein the decoder generates a synchronization control signal according to the frame switching control signal received by the transceiver, and the transceiver transmits the synchronization control signal to the projecting module, so the projecting module adjusts the output time sequence of the first projected image and the second projected image according to the synchronization control signal.

3. The decoder as claimed in claim 1, wherein the decoder suspends the output of the first image data and the second image data from the decoding circuit to the projecting module for a predetermined time, so as to adjust the output time sequence of the first projected image and the second projected image outputted from the projecting module.

4. The decoder as claimed in claim 1, wherein the decoder alters an output frequency of the first image data and the second image data outputted from the decoding circuit to the projecting module, so as to adjust the output time sequence of the first projected image and the second projected image outputted from the projecting module.

5. The decoder as claimed in claim 1, wherein the decoder alters an output frequency of the first projected image and the second projected image outputted from the projecting module, so as to adjust the output time sequence of the first projected image and the second projected image outputted from the projecting module.

6. A projecting system, comprising:
a projecting module, receiving a first image data and a second image data and outputting a frame switching control signal, wherein the projecting module generates a first projected image according to the first image data, and generates a second projected image according to the second image data; and
a decoder, coupled to the projecting module, the decoder comprising:
a decoding circuit, receiving and decoding a three-dimensional video signal to generate the first image data and the second image data, and the decoding circuit adjusting an output time sequence of the first projected image and the second projected image outputted from the projecting module according to the received frame switching control signal; and
a transceiver, coupled to the decoding circuit to receive and transmit the frame switching control signal to the decoding circuit.

7. The projecting system as claimed in claim 6, wherein the decoder generates a synchronization control signal according to the frame switching control signal received by the transceiver, and the transceiver transmits the synchronization control signal to the projecting module, so the projecting module adjusts the output time sequence of the first projected image and the second projected image according to the synchronization control signal.

8. The projecting system as claimed in claim 6, wherein the decoder suspends the output of the first image data and the second image data from the decoding circuit to the projecting module for a predetermined time, so as to adjust the output time sequence of the first projected image and the second projected image outputted from the projecting module.

9. The projecting system as claimed in claim 6, wherein the decoder alters an output frequency of the first image data and the second image data outputted from the decoding circuit to the projecting module, so as to adjust the output time sequence of the first projected image and the second projected image outputted from the projecting module.

10. The projecting system as claimed in claim 6, wherein the decoder alters an output frequency of the first projected image and the second projected image outputted from the projecting module, so as to adjust the output time sequence of the first projected image and the second projected image outputted from the projecting module.

11. The projecting system as claimed in claim 6, further comprising:
a pair of light-shielding glasses, having a first light-shielding unit and a second light-shielding unit, image receiving operations of the first light-shielding unit and the second light-shielding unit being turned on and off according to the frame switching control signal, and the image receiving operations of the first light-shielding unit and the second light-shielding unit are opposite to each other.

12. The projecting system as claimed in claim 11, wherein the first light-shielding unit and the second light-shielding unit receive the first projected image and the second projected image respectively.

13. An image processing method of a projecting system, comprising:
providing a decoding circuit to receive and decode a three-dimensional video signal, and to generate a first image data and a second image data;
providing a projecting module to generate a first projected image according to the first image data, generate a second projected image according to the second image data, and to output a frame switching control signal, wherein the decoding circuit adjusts an output time sequence of the first projected image and the second projected image outputted from the projecting module according to the received frame switching control signal; and
providing a transceiver to receive and transmit the frame switching control signal to the decoding circuit.

14. The image processing method as claimed in claim 13, wherein the decoder generates a synchronization control signal according to the frame switching control signal received by the transceiver, and the transceiver transmits the synchronization control signal to the projecting module, so that the projecting module adjusts the output time sequence of the first projected image and the second projected image according to the synchronization control signal.

15. The image processing method as claimed in claim 13, wherein the decoder suspends the output of the first image data and the second image data from the decoding circuit to the projecting module for a predetermined time, so as to adjust the output time sequence of the first projected image and the second projected image outputted from the projecting module.

16. The image processing method as claimed in claim 13, wherein the decoder alters an output frequency of the first image data and the second image data outputted from the decoding circuit to the projecting module, so as to adjust the output time sequence of the first projected image and the second projected image outputted from the projecting module.

17. The image processing method as claimed in claim 13, wherein the decoder alters an output frequency of the first projected image and the second projected image outputted from the projecting module, so as to adjust the output time sequence of the first projected image and the second projected image outputted from the projecting module.
